(19) United States
(12) Patent Application Publication
(10) Pub. No.: US 2023/0150861 A1
(43) Pub. Date: May 18, 2023

(54) GLASS, GLASS FORMING METHOD, PRESSING APPARATUS, AND CALENDER

(71) Applicant: Siping Hongda Hydraulic Machinery Manufacturing Co., Ltd., Siping (CN)

(72) Inventor: Xiaoyi SHAN, SiPing (CN)

(21) Appl. No.: 18/154,835

(22) Filed: Jan. 15, 2023

Related U.S. Application Data
(63) Continuation of application No. PCT/CN2020/122371, filed on Oct. 21, 2020.

(30) Foreign Application Priority Data
Sep. 6, 2020 (CN) 202010924998.X

(51) Int. Cl. C03C 3/087; C03C 23/00; B24B 1/00

(52) U.S. Cl. CPC C03C 3/087; C03C 23/007; B24B 1/00

(57) ABSTRACT

Glass, a glass forming method, a pressing apparatus, and a calender. The glass is made by a calendering method, and the glass comprises raw materials of SiO₂, Li₂O, Na₂O, CaO, MgO, Al₂O₃, and TiO₂+ZrO₂. The pressing apparatus comprises two oppositely arranged pressing mechanisms; each pressing mechanism comprises a base, a cross beam, a pressing rod, a stand column, and a driving mechanism; the stand column and the driving mechanism are mounted on the base; the first end of the pressing rod, the end of the stand column distant from the base, and the end of the driving mechanism distant from the base are all pivoted to the cross beam; and the stand column is located between the pressing rod and the driving mechanism. The calender comprises the pressing mechanisms. The glass has better performance and higher mechanical strength.

### CROSS-REFERENCE TO RELATED APPLICATIONS

The present application claims priority to the Chinese Patent Application with an application number of 202010924998.X and a title of “Glass, Glass Forming Method, Pressing Apparatus, and Calender”, filed to China National Intellectual Property Administration on Sep. 6, 2020, the disclosures of which are hereby incorporated by reference.

### TECHNICAL FIELD

The present application relates to the field of glass forming, in particular to glass, a glass forming method, a pressing apparatus, and a calender.

### BACKGROUND OF THE PRESENT INVENTION

Generally, appearance protective glass and window protective glass of electronic products need to have the properties of high strength, wear resistance, scratch resistance, fall resistance, high optical clarity, and sensitive and accurate responses to touch.

According to different forming processes, production of the appearance protective glass and the window protective glass of the existing electronic products can be divided into a float forming method (referred to as a float method), an overflow pulldown method (referred to as an overflow method), a secondary drawing method, a slit method and a secondary polishing method. Among them, the float forming method and the overflow pulldown method are two mainstream methods. In order to improve indexes such as strength and hardness of glass surfaces, alumina oxides with a higher composition content than that of conventional glass are added to glass formulas of the float forming method and the overflow pulldown method. The alumina content of the float forming method is above 3.5%; and the alumina content of the overflow pulldown method is above 15%. Due to the different alumina contents, scratch resistance, fall resistance, warpage and other performance indexes of high-alumina silica glass produced by the float forming method are not as good as those of the overflow pulldown method, so high-end touch products are mainly occupied by the glass produced by the overflow pulldown method.

A process of the overflow pulldown method is one of basic technologies for flat glass manufacturing and production, and also the basic and most mature technology for ultra-thin glass manufacturing at present.

A course of the process of the overflow pulldown method is: a glass raw material is melted into molten glass in a pool furnace, and then cooled through a clarification section and a homogenization section of a platinum channel; the molten glass horizontally flows into an overflow brick through an L-tube made of platinum; the upper part of the overflow brick is provided with a molten glass collection tank (overflow tank); and when the overflow tank is full, the molten glass will overflow from both sides of the top of the tank. Under the action of gravity, two pieces of glass are formed by flowing downward along the outer surface of the overflow brick, and are finally combined under the overflow brick to form a single piece of glass. Because the molten glass flows on the surface of the overflow brick, the thickness of a plate root foundation formed by merging of the molten glass at a brick tip is much thicker than that of a plate root foundation formed by a slit pulldown method, which increases the difficulty of thinning. In addition, because the molten glass overflows out from the overflow tank without constraints of a mold, distribution uniformity (overflow speed) of the molten glass on the upper weir of the overflow brick is difficult to be consistent, which affects uniformity of the thickness of a glass plate.

Meanwhile, the overflow pulldown method has the strictest requirements on melting, clarification and homogenization of the molten glass. In order to achieve accurate control of the temperature of the molten glass, each production line needs to consume 800-1,000 kg of platinum to make a long glass channel; the temperature of the molten glass is adjusted by electrically heating the platinum channel; and these precious metals will be oxidized and volatilized continuously. Therefore, the method makes manufacturing cost of the production line very high.

In addition, the raw material component needed for melting the molten glass, which matches with the above overflow method production process, is usually high-alumina silicate or high-alumina borosilicate; and a weight percentage of Al₂O₃ in the glass is usually ≥15%.

A specific forming process of the float forming method is: after the molten glass continuously flows out of a melting furnace, the molten glass floats on a liquid surface of metal tin filled with a protective gas to form a glass ribbon with uniform thickness and smooth surface; and then the glass ribbon is annealed. Because surface quality of the glass on the side contacting with a tin solution is inferior to that of the overflow process, it is necessary to add grinding and polishing equipment in float forming; and the cost is higher. When glass with the thickness of less than 1.0 mm is drawn by the float method, the float process needs to thin the glass thickness from a free thickness of 6.0 mm to a required thickness; the process can only rely on an edge roller to exert tension of transverse thinning, which requires a lot of external force; because a thinning area is very long, a large number of edge rollers need to be arranged; because each edge roller can only exert external force on one side, an effect thereof is worse than that of a pair-roller edge roller; and a difference between the thickness of the glass ribbon outside an indentation of the edge roller and the thickness of a qualified plate further increases with thinning of the glass, which can easily form local stress concentration on edges. Meanwhile, in a forming stage of the float forming method, the glass plate with the required width and thickness must be drawn by the edge roller on the surface of the tin solution in a forming tin tank. Because of the edge roller forming, the forming temperature in the interval is generally 830°-920°; and the corresponding viscosity is 10⁶ Pa·S-10⁵ Pa·S. If the forming temperature is too high or the viscosity is not properly controlled, forming will fail.

By the above float forming method, the thickness uniformity, waviness and other performance indexes of the produced glass are poor.

The appearance protective glass and the window protective glass of the electronic products can be divided into soda-lime silicate glass and high-alumina silicate glass according to different production formulas. A commonly used high-performance formula is high-alumina silicate glass, which is mainly a SiO₂—Al₂O₃—RO—R₂O system. In the composition, SiO₂ is an organizer oxide of a glass network, which can improve flexural strength, chemical stability and thermal stability of the glass, but SiO₂ is a substance relatively difficult to melt. Al₂O₃ content needs to be more than 15%. Al₂O₃ can greatly improve mechanical strength of the glass, but in a melting process, the high content of Al₂O₃ has a greater impact on viscosity of the glass than that of SiO₂, which slows down the melting speed and prolongs the clarification time of the glass. The content of RO in the glass is usually above 12%; and increase of RO alkaline earth metal oxides will lead to decrease of an elastic modulus and flexural strength. The content of R₂O in the glass is usually more than 13%; and increase of R₂O alkaline earth metal oxides will also lead to the decrease of the elastic modulus and the flexural strength.

Therefore, in an operation course of the process, on the basis of meeting needs of melting and forming, mass components of Al₂O₃, RO and R₂O should be reduced as much as possible. Therefore, finding a novel glass ingredient composition not only can improve the elastic modulus and flexural strength of the cover glass, but also can improve the mechanical strength of the glass.

The present application proposes a novel glass forming method in order to solve the problems that the overflow pulldown method has too high cost during manufacturing of the glass, the thickness uniformity and waviness indexes of the products produced by the float forming method are poor, the interval range of the forming temperature is narrow and the common oxides of Al₂O₃, RO and R₂O in the glass raw material proportioning bring differences to the product performance indexes.

At present, the widely applied calender set structure in the market generally comprises a calender body, a calendering upper main roller, a calendering lower main roller, a rocker arm, a screw rod reducer and a mechanical pressure apparatus, wherein both the calendering upper main roller and the calendering lower main roller are mounted on the calender body; arrangement directions of the calendering upper main roller and the calendering lower main roller are consistent with a longitudinal direction of the calender body; the rocker arm is pivoted to the calender body; one end of the rocker arm is connected to the calendering upper main roller; the screw rod reducer is mounted on the other end of the rocker arm; the mechanical pressure apparatus is mounted on the calender body; and the mechanical pressure apparatus is located above the calendering upper main roller. Specifically, when glass needs to be pressed, a gap between the calendering upper main roller and the calendering lower main roller should be adjusted at first, so that the glass can be located in the gap. By making the screw rod reducer work, a screw rod drives the rocker arm to rotate at a certain angle; and then the calendering upper main roller moves up and down. When the produced glass is thinner, the gap will be smaller. However, in normal production, when high-temperature molten glass is squeezed between the calendering upper main roller and the calendering lower main roller, the calendering upper main roller will be subjected to great buoyancy; and the thinner the produced glass is, the greater the buoyancy will be. Therefore, a certain downward pressure must be applied to the calendering upper main roller by the mechanical pressure apparatus to overcome the upward buoyancy generated by the glass to the calendering upper main roller. Specifically, the mechanical pressure apparatus comprises a rotating force claw and a pressing rod. When the thin glass is produced, the force claw is manually rotated; the force claw is rotated so as to drive a pressing rod head of the pressing rod to move downward; and certain force is applied to the calendering upper main roller. It should be noted that the downward pressure is mainly to overcome the buoyancy generated by the molten glass between the calendering upper main roller and the calendering lower main roller on the calendering upper main roller. The thinner the produced glass is, the greater the applied pressure will be. For example, the pressure of 5,000 N-10,000 N is required when 3.2 mm glass is produced; the pressure of 16,000 N-28,000 N is required when 2.5 mm glass is produced; and the pressure of 42,000 N-63,000 N is required when 2.0 mm glass is produced.

Therefore, the above calender set structure mainly has two disadvantages. First, operators need to pay a lot of physical labor; and the operators are easily radiated by heat of the high-temperature molten glass in an open area in front of the calendering rollers, which makes it difficult for the operators to operate. Second, the size of the pressure applied on the calendering upper main roller is adjusted manually. Because the manually applied force is too small (generally less than 28,000 N), it can only meet production of some conventional glass with relatively large thicknesses (≥2.5 mm), but cannot meet production of glass with relatively small thicknesses (<2.5 mm).

At present, the conventional thickness of the glass is relatively thin; and production and manufacturing methods thereof are mainly the float forming method and the overflow pulldown method. The glass produced by the two methods has poor performance and low mechanical strength; and meanwhile, the calender used in a current calendering method cannot press the glass with the relatively thin thickness, which will also lead to poor performance and low mechanical strength of the produced glass.

### SUMMARY OF PRESENT INVENTION

The purpose of the present application is to provide a glass, a glass forming method, a pressing apparatus, and a calender, so that the manufactured glass has good performance and high mechanical strength.

In a first aspect, the present application provides glass, wherein the glass comprises the following raw materials in parts by weight: 61-76 parts of SiO₂, 6-10 parts of Li₂O, 2-12 parts of Na₂O, 5-0 parts of CaO, 5-0 parts of MgO, 16-0 parts of Al₂O₃ and 5-2 parts of TiO₂+ZrO₂.

As an optional implementation, the glass comprises the following raw materials in parts by weight: 76 parts of SiO₂, 10 parts of Li₂O, 12 parts of Na₂O and 2 parts of TiO₂+ZrO₂.

As an optional implementation, the glass comprises the following raw materials in parts by weight: 61 parts of SiO₂, 6 parts of Li₂O, 2 parts of Na₂O, 5 parts of CaO, 5 parts of MgO, 16 parts of Al₂O₃ and 5 parts of TiO₂+ZrO₂.

As an optional implementation, the glass comprises the following raw materials in parts by weight: 70 parts of SiO₂, 8 parts of Li₂O, 10 parts of Na₂O, 1.5 parts of CaO, 1.5 parts of MgO, 5 parts of Al₂O₃ and 4 parts of TiO₂+ZrO₂.

In a second aspect, the present application provides a glass forming method, wherein the glass is made by the glass forming method; and the glass forming method comprises:

blending raw materials for making glass to obtain the raw materials for making the glass;

processing the raw materials of the glass to obtain molten glass;

processing the molten glass by a calendering method to obtain amorphous glass;

processing the amorphous glass to obtain crystalline glass;

polishing the crystalline glass to obtain formed glass.

As an optional implementation, processing the amorphous glass to obtain the crystalline glass comprises:

processing the amorphous glass by an annealing process to obtain glass in a transition state;

crystallizing the glass in the transition state to obtain the crystalline glass;

cutting the crystalline glass to obtain a regular shape of the crystalline glass; or,

processing the amorphous glass by an annealing process to obtain glass in a transition state;

cutting the glass in the transition state to obtain a regular shape of the glass in the transition state;

crystallizing the cut glass in the transition state to obtain the crystalline glass;

wherein the glass in the transition state is the glass after an amorphous state and before a crystalline state.

As an optional implementation, crystallizing comprises online crystallizing or offline crystallizing.

As an optional implementation, after polishing the crystalline glass to obtain the formed glass, the method further comprises:

performing chemical tempering on the formed glass.

In a third aspect, the present application provides a pressing apparatus, which is used for processing the molten glass to obtain the amorphous glass in the above forming method. The pressing apparatus provided by the present application comprises two oppositely arranged pressing mechanisms; each pressing mechanism comprises a base, a cross beam, a pressing rod, a stand column, and a driving mechanism; the stand column and the driving mechanism are mounted on the base; the first end of the pressing rod, the end of the stand column distant from the base, and the end of the driving mechanism distant from the base are all pivoted to the cross beam; and the stand column is located between the pressing rod and the driving mechanism.

As an optional implementation, the driving mechanism comprises a motor reducer and a turbine lifting reducer; and the motor reducer is connected to an input shaft of the turbine lifting reducer through a coupling.

As an optional implementation, the driving mechanism comprises a handwheel and a turbine lifting reducer; and the handwheel is rotationally connected to an input shaft of the turbine lifting reducer through a positioning pin.

As an optional implementation, the driving mechanism is a mechanical jack.

As an optional implementation, the pressing rod comprises an upper pressing rod and a pressing rod head; a first end of the upper pressing rod is pivoted to the cross beam; and a second end of the upper pressing rod is in threaded connection with the pressing rod head.

As an optional implementation, the pressing apparatus provided by the present application further comprises a pressure sensor; a first end of pressure sensor is connected to the driving mechanism; and a second end of the pressure sensor is pivoted to the cross beam.

As an optional implementation, the pressing apparatus provided by the present application further comprises a limiting switch; the limiting switch is arranged on the stand column; the limiting switch has a first contact point and a second contact point; the first contact point can be abutted against a first end surface of the pressure sensor; and the second contact point can be abutted against a second end surface of the pressure sensor.

In a fourth aspect, the present application provides a calender, which comprises a calender body, a calendering upper main roller, a calendering lower main roller and the pressing apparatus, wherein the calendering upper main roller and the calendering lower main roller are oppositely arranged on the calender body; distribution directions of the calendering upper main roller and the calendering lower main roller are consistent with a longitudinal direction of the calender body; the molten glass can be located between the calendering upper main roller and the calendering lower main roller; the pressing apparatus is arranged on the calender body; and the second end of the pressing rod can press against the calendering upper main roller.

As an optional implementation, the calender body comprises a first body and a second body; the second body comprises a workbench; the workbench is located above the first body; the calendering upper main roller and the calendering lower main roller are both arranged on the first body; the pressing apparatus is arranged on the workbench; and the pressing rod penetrates through the workbench.

As an optional implementation, the calender further comprises a calendering upper main roller motor, a calendering lower main roller motor, an electric control cabinet and a touch screen, wherein a motor shaft of the calendering upper main roller motor is connected to the calendering upper main roller; a motor shaft of the calendering lower main roller motor is connected to the calendering lower main roller; the electric control cabinet and the touch screen are arranged on the calender body; and the calendering upper main roller motor, the calendering lower main roller motor and the touch screen are all electrically connected to the electric control cabinet.

In the glass, glass forming method, pressing apparatus, and calender provided by the present application, the glass comprises the following raw materials in parts by weight: 61-76 parts of SiO₂, 6-10 parts of Li₂O, 2-12 parts of Na₂O, 5-0 parts of CaO, 5-0 parts of MgO, 16-0 parts of Al₂O₃ and 5-2 parts of TiO₂+ZrO₂. Therefore, the glass provided by the present application has better performance and higher mechanical strength.

The structure, other inventive purposes and beneficial effects of the present application will be more obvious and easier to understand through the description of preferred embodiments in conjunction with the accompanying drawings.

### DESCRIPTION OF THE DRAWINGS

In order to more clearly explain embodiments of the present application or technical solutions in the prior art, drawings needed in the description of the embodiments or the prior art will be briefly introduced. Obviously, the drawings in the following description are some embodiments of the present application; and for those ordinary skilled in the art, other drawings can be obtained according to these drawings without contributing creative labor.

FIG. 1a is a schematic diagram of a preparation process of an existing overflow pulldown method;

FIG. 1b is a schematic diagram of a glass forming process by an existing overflow pulldown method;

FIG. 2 is a schematic diagram of a preparation process of glass of an existing float method process;

FIG. 3a is a broken-line statistical diagram of changes of an elastic modulus and flexural strength of existing glass with RO contents;

FIG. 3b is a broken-line statistical diagram of changes of an elastic modulus and flexural strength of existing glass with R₂O contents;

FIG. 4a is a structural schematic diagram of an existing calender set structure;

FIG. 4b is a side view of FIG. 4a;

FIG. 4c is an exploded view of an existing calender set structure;

FIG. 5a is a schematic diagram of a step process of a glass forming method provided by an embodiment of the present application;

FIG. 5b is a schematic diagram of a step process of processing amorphous glass to obtain crystalline glass in a glass forming method provided by an embodiment of the present application;

FIG. 5c is a schematic diagram of another step process of processing amorphous glass to obtain crystalline glass in a glass forming method provided by an embodiment of the present application;

FIG. 6a is a structural schematic diagram of a pressing apparatus provided by an embodiment of the present application;

FIG. 6b is a side view of FIG. 6a;

FIG. 7a is a schematic diagram of a first structure of a calender provided by an embodiment of the present application;

FIG. 7b is a cross-sectional view of FIG. 7a along A-A;

FIG. 8a is a schematic diagram of a second structure of a calender provided by an embodiment of the present application;

FIG. 8b is a cross-sectional view of FIG. 8a along B-B;

FIG. 9a is a schematic diagram of a third structure of a calender provided by an embodiment of the present application;

FIG. 9b is a cross-sectional view of FIG. 9a along C-C;

FIG. 10a is a schematic diagram of a fourth structure of a calender provided by an embodiment of the present application;

FIG. 10b is a cross-sectional view of FIG. 10a along D-D;

FIG. 11a is a schematic diagram of a fifth structure of a calender provided by an embodiment of the present application;

FIG. 11b is a side view of FIG. 11a;

FIG. 12a is a schematic diagram of a sixth structure of a calender provided by an embodiment of the present application;

FIG. 12b is a side view of FIG. 12a;

FIG. 13a is a schematic diagram of a seventh structure of a calender provided by an embodiment of the present application; and

FIG. 13b is a side view of FIG. 13a.

### DESCRIPTION OF REFERENCE SIGNS

1—pool furnace; 2—platinum channel; 21—clarification section; 22—homogenization section; 3—L-tube; 4—overflow brick; 41—overflow tank; 5—melting furnace; 6, 60—calender body; 7, 70—calendering upper main roller; 71—upper bearing cover; 8, 80—calendering lower main roller; 9—rocker arm; 10—screw rod reducer; 20—mechanical pressure apparatus; 201—rotating force claw; 202, 33—pressing rod; 2021, 332—pressing rod head; 30—pressing mechanism; 31—base; 32—cross beam; 331—upper pressing rod; 34—stand column; 35—driving mechanism; 351—motor reducer; 352—turbine lifting reducer; 40—pressure sensor; 50—limiting switch; 61—first body; 62—second body; 90—calendering upper main roller motor; 100—calendering lower main roller motor; 110—electric control cabinet; 120—touch screen; 130—auxiliary roller; 140—movable roller; and 150—mechanical jack.

### DETAILED DESCRIPTION OF PREFERRED EMBODIMENTS

In order to make the purpose, technical solutions and advantages of embodiments of the present application clearer, the technical solutions in the embodiments of the present application will be clearly and completely described below with reference to the drawings in the embodiments of the present application. Obviously, the described embodiments are part of the embodiments of the present application, but not all the embodiments.

Based on the embodiments in the present application, all other embodiments obtained by those ordinary skilled in the art without creative labor belong to the scope of protection of the present application. In case of no conflict, the following embodiments and features in the embodiments can be combined with each other.

Generally, appearance protective glass and window protective glass of electronic products need to have the properties of high strength, wear resistance, scratch resistance, fall resistance, high optical clarity, and sensitive and accurate responses to touch.

According to different forming processes, production of the appearance protective glass and window protective glass of the existing electronic products can be divided into a float forming method (referred to as a float method), an overflow pulldown method (referred to as an overflow method), a secondary drawing method, a slit method and a secondary polishing method. Among them, the float forming method and the overflow pulldown method are two mainstream methods. In order to improve indexes such as strength and hardness of glass surfaces, alumina oxides with a higher composition content than that of conventional glass are added to glass formulas of the float forming method and the overflow pulldown method. The alumina content of the float forming method is above 3.5%; and the alumina content of the overflow pulldown method is above 15%. Due to the different alumina contents, scratch resistance, fall resistance, warpage and other performance indexes of high-alumina silica glass produced by the float forming method are not as good as those of the overflow pulldown method, so high-end touch products are mainly occupied by the glass produced by the overflow pulldown method.

A process of the overflow pulldown method is one of basic technologies for flat glass manufacturing and production, and also the basic and most mature technology for ultra-thin glass manufacturing at present.

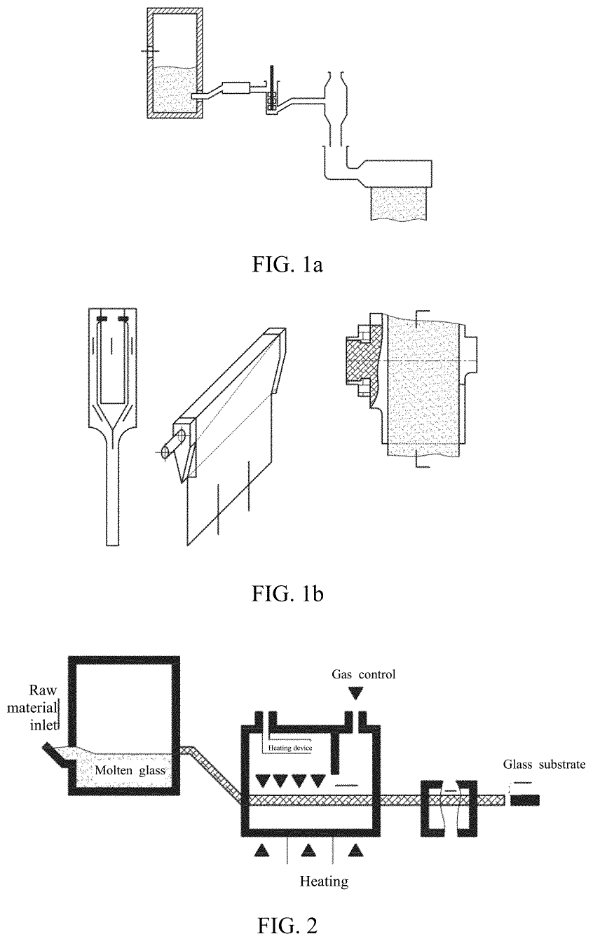

FIG. 1a is a schematic diagram of a preparation process of an existing overflow pulldown method. FIG. 1b is a schematic diagram of a glass forming process by an existing overflow pulldown method.

As shown in FIG. 1a and FIG. 1b, a course of the process of the overflow pulldown method is: a glass raw material is melted into molten glass in a pool furnace 1, and then cooled through a clarification section 21 and a homogenization section 22 of a platinum channel 2; the molten glass horizontally flows into an overflow brick 4 through an L-tube 3 made of platinum; the upper part of the overflow brick 4 is provided with a molten glass collection tank (overflow tank 41); and when the overflow tank 41 is full, the molten glass will overflow from both sides of the top of the tank. Under the action of gravity, two pieces of glass are formed by flowing downward along the outer surface of the overflow brick 4, and are finally combined under the overflow brick 4 to form a single piece of glass.

Because the molten glass flows on the surface of the overflow brick, the thickness of a plate root foundation formed by merging of the molten glass at a brick tip is much thicker than that of a plate root foundation formed by a slit pulldown method, which increases the difficulty of thinning. In addition, because the molten glass overflows out from the overflow tank without a constraint of a mold, distribution uniformity (overflow speed) of the molten glass on the upper weir of the overflow brick is difficult to be consistent, which affects uniformity of the thickness of a glass plate.

Meanwhile, the overflow pulldown method has the strictest requirements on melting, clarification and homogenization of the molten glass. In order to achieve accurate control of the temperature of the molten glass, each production line needs to consume 800-1,000 kg of platinum to make a long glass channel; the temperature of the molten glass is adjusted by electrically heating the platinum channel; and these precious metals will be oxidized and volatilized continuously. Therefore, the method makes manufacturing cost of the production line very high.

In addition, the raw material component needed for melting the molten glass, which matches with the above overflow method production process, is usually high-alumina silicate or high-alumina borosilicate; and a weight percentage of Al₂O₃ in the glass is usually ≥15%.

As shown in FIG. 2, a specific forming process of the float forming method is: after the molten glass continuously flows out of a melting furnace 5, the molten glass floats on a liquid surface of metal tin filled with a protective gas to form a glass ribbon with uniform thickness and smooth surface; and then the glass ribbon is annealed. Because surface quality of the glass on the side contacting with a tin solution is inferior to that of the overflow process, it is necessary to add grinding and polishing equipment in float forming; and the cost is higher. When glass with the thickness of less than 1.0 mm is drawn by the float method, the float process needs to thin the glass thickness from a free thickness of 6.0 mm to a required thickness; the process can only rely on an edge roller to exert tension of transverse thinning, which requires a lot of external force; because the length of a thinning area is very long, a large number of edge rollers need to be arranged; because each edge roller can only exert external force on one side, an effect thereof is worse than that of a pair-roller edge roller; and a difference between the thickness of the glass ribbon outside an indentation of the edge roller and the thickness of a qualified plate further increases with thinning of the glass, which can easily form local stress concentration on edges. Meanwhile, in a forming stage of the float forming method, the glass plate with the required width and thickness must be drawn by the edge roller on the surface of the tin solution in a forming tin tank. Because of the edge roller forming, the forming temperature in the interval is generally 830°-920°; and the corresponding viscosity is 10⁶ Pa·S-10⁵ Pa·S. If the forming temperature is too high or the viscosity is not properly controlled, forming will fail.

By the above float forming method, the thickness uniformity, waviness and other performance indexes of the produced glass are poor.

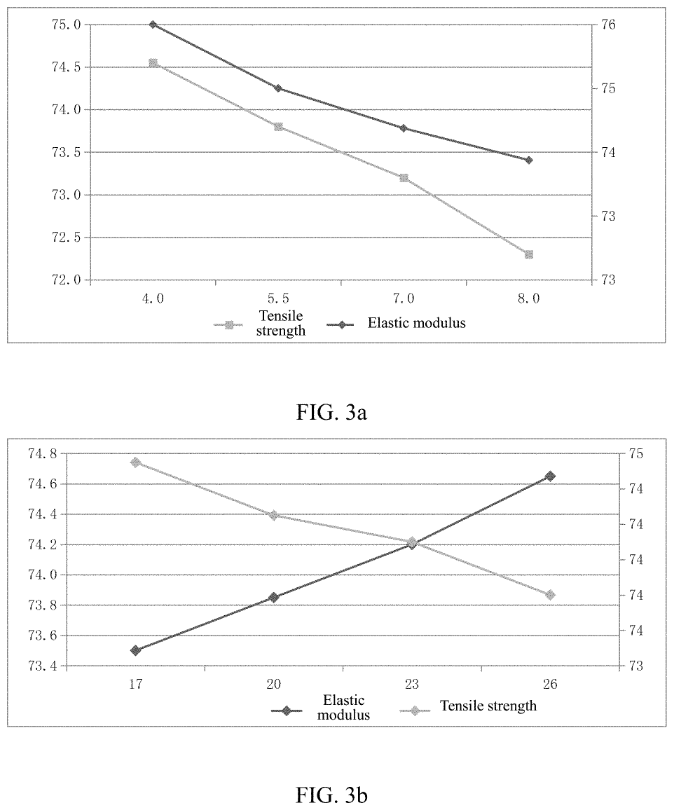

FIG. 3a is a broken-line statistical diagram of changes of an elastic modulus and flexural strength of existing glass with RO contents. FIG. 3b is a broken-line statistical diagram of changes of an elastic modulus and flexural strength of existing glass with R₂O contents.

As shown in FIG. 3a and FIG. 3b, the appearance protective glass and window protective glass of the electronic products can be divided into soda-lime silicate glass and high-alumina silicate glass according to different production formulas. A commonly used high-performance formula is high-alumina silicate glass, which is mainly a SiO₂—Al₂O₃—RO—R₂O system. In the composition, SiO₂ is an organizer oxide of a glass network, which can improve flexural strength, chemical stability and thermal stability of the glass, but SiO₂ is a substance relatively difficult to melt. Al₂O₃ content needs to be more than 15%. Al₂O₃ can greatly improve mechanical strength of the glass, but in a melting process, the high content of Al₂O₃ has a greater impact on viscosity of the glass than that of SiO₂, which slows down the melting speed and prolongs the clarification time of the glass. The content of RO in the glass is usually above 12%; and increase of RO alkaline earth metal oxides will lead to decrease of an elastic modulus and flexural strength. The content of R₂O in the glass is usually more than 13%; and increase of R₂O alkaline earth metal oxides will also lead to the decrease of the elastic modulus and the flexural strength. RO is generally an oxide such as MgO or CaO; and R₂O is generally an oxide such as K₂O or Na₂O.

Therefore, in an operation course of the process, on the basis of meeting needs of melting and forming, mass components of Al₂O₃, RO and R₂O should be reduced as much as possible or should not be added. Therefore, finding a novel glass ingredient composition can not only improve the elastic modulus and flexural strength of the cover glass, but can also improve the mechanical strength of the glass.

The present application proposes a novel glass forming method in order to solve the problems that the overflow pulldown method of the glass generates too much cost, the thickness uniformity and waviness indexes of the products produced by the float forming method are poor, the interval range of the forming temperature is narrow and the common oxides of Al₂O₃, RO and R₂O in the glass raw material proportioning bring differences to the product performance indexes.

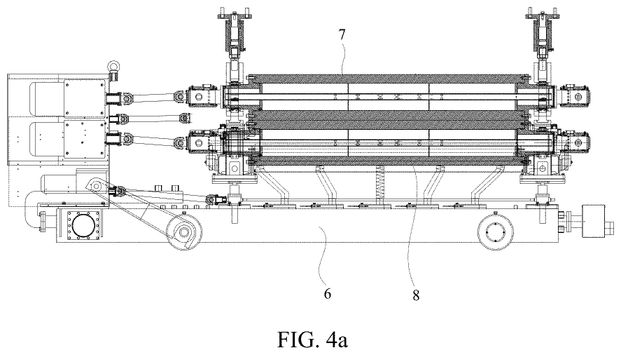

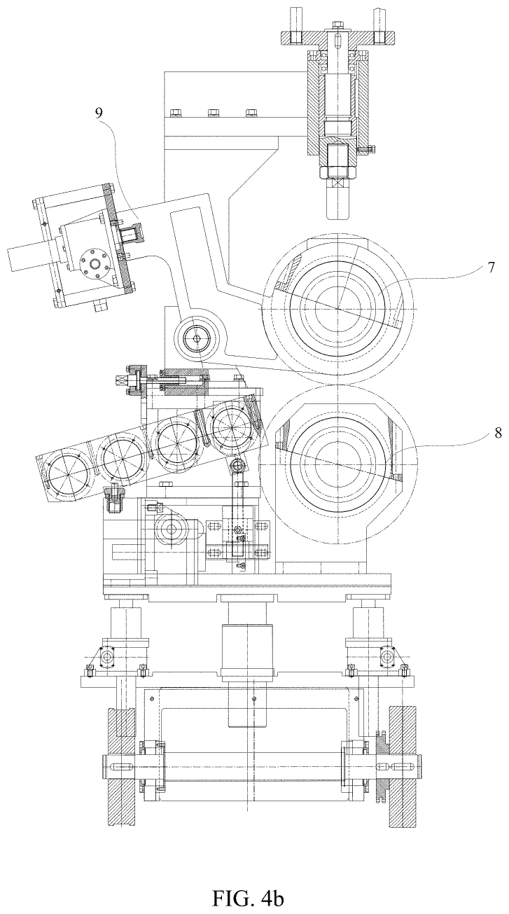

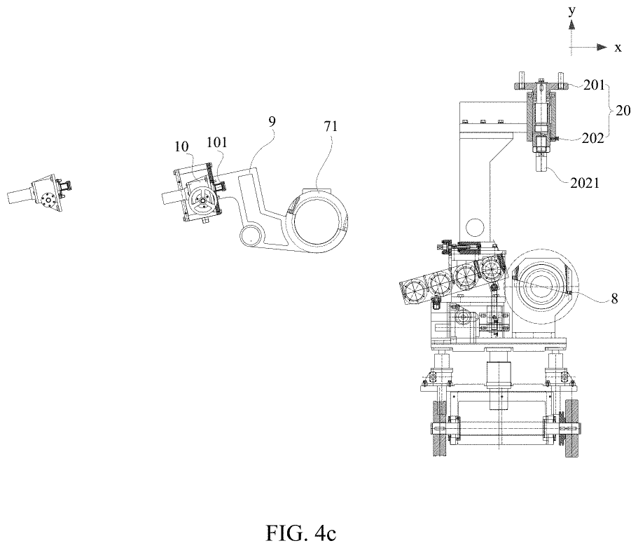

FIG. 4a is a structural schematic diagram of an existing calender set structure. FIG. 4b is a side view of FIG. 4a. FIG. 4c is an exploded view of an existing calender set structure.

As shown in FIG. 4a to FIG. 4c, a widely applied calender set structure in the market generally comprises a calender body 6, a calendering upper main roller 7, a calendering lower main roller 8, a rocker arm 9, a screw rod reducer 10 and a mechanical pressure apparatus 20, wherein both the calendering upper main roller 7 and the calendering lower main roller 8 are mounted on the calender body 6; arrangement directions of the calendering upper main roller 7 and the calendering lower main roller 8 are consistent with a longitudinal direction of the calender body 6 (y direction in the diagram); the rocker arm 9 is pivoted to the calender body 6; one end of the rocker arm 9 is connected to the calendering upper main roller 7; the screw rod reducer 10 is mounted on the other end of the rocker arm 9; the mechanical pressure apparatus 20 is mounted on the calender body 6; and the mechanical pressure apparatus 20 is located above the calendering upper main roller 7. Specifically, when glass needs to be pressed, a gap between the calendering upper main roller 7 and the calendering lower main roller 8 should be adjusted first, so that the glass can be located in the gap. By making the screw rod reducer 10 work, a screw rod 101 drives the rocker arm 9 to rotate. Specifically, the front end of the rocker arm 9 supports the calendering upper main roller 7; and an upper bearing cover 71 of the calendering upper main roller 7 is connected to the lower part of the front end of the rocker arm 9 by bolts. When the calendering upper main roller 7 is mounted, the upper bearing cover 71 is opened; and the rocker arm 9 is fixed with the calender body 6 through a pin shaft, so that the rocker arm can rotate around a connection point between the rocker arm 9 and the calender body 6 to form lever force. The screw rod reducer 10 is fixed at the rear end of the rocker arm 9, so that the screw rod on the screw rod reducer 10 can jack at least part of the calender body 6, so that the front end of the rocker arm 9 can support the calendering upper main roller 7 by the pin shaft connecting the rocker arm 9 and the calender body 6. When the gap between the calendering upper main roller 7 and the calendering lower main roller 8 needs to be adjusted, a handwheel on the screw rod reducer 10 is manually shaken to make the calendering upper main roller 7 move up and down. When the produced glass is thinner, the gap will be smaller. However, in normal production, when high-temperature molten glass is squeezed between the calendering upper main roller 7 and the calendering lower main roller 8, the calendering upper main roller 7 will be subjected to great buoyancy; and the thinner the produced glass is, the greater the buoyancy will be. Therefore, a certain downward pressure must be applied to the calendering upper main roller 7 by the mechanical pressure apparatus 20 to overcome the upward buoyancy generated by the glass to the calendering upper main roller 7. Specifically, the mechanical pressure apparatus 20 comprises a rotating force claw 201 and a pressing rod 202. When the thin glass is produced, the force claw 201 is manually rotated; the force claw 201 is rotated so as to drive a pressing rod head 2021 of the pressing rod 202 to move downward; and certain force is applied to the calendering upper main roller 7. It should be noted that the downward pressure is mainly to overcome the buoyancy generated by the molten glass between the calendering upper main roller 7 and the calendering lower main roller 8 on the calendering upper main roller 7. The thinner the produced glass is, the greater the applied pressure will be. For example, the pressure of 5,000 N-10,000 N is required when 3.2 mm glass is produced; the pressure of 16,000 N-28,000 N is required when 2.5 mm glass is produced; and the pressure of 42,000 N-63,000 N is required when 2.0 mm glass is produced.

Therefore, the above calender set structure mainly has two disadvantages. First, operators have to pay a lot of physical labor; and the operators are easily radiated by heat of the high-temperature molten glass in an open area in front of the calendering rollers, which makes it difficult for the operators to operate. Second, the size of the pressure applied on the calendering upper main roller is adjusted manually. Because the manually applied force is too small (generally less than 28,000 N), it can only meet production of some conventional glass with relatively large thicknesses, but cannot meet production of glass with relatively small thicknesses.

At present, the conventional thickness of the glass is relatively thin; and production and manufacturing methods thereof are mainly the float forming method and the overflow pulldown method. The glass produced by the two methods has poor performance and low mechanical strength; and meanwhile, the calender used in a current calendering method cannot press the glass with the relatively thin thickness, which will also lead to the poor performance and low mechanical strength of the produced glass.

In order to overcome the above defects, the present application provides a glass, a glass forming method, a pressing apparatus, and a calender, which can optimize the performance of the glass and improve the mechanical strength of the glass.

An embodiment of the present application provides a glass which comprises the following raw materials in parts by weight: 61-76 parts of SiO₂, 6-10 parts of Li₂O, 2-12 parts of Na₂O, 5-0 parts of CaO, 5-0 parts of MgO, 16-0 parts of Al₂O₃ and 5-2 parts of TiO₂+ZrO₂.

Specifically, SiO₂ is a glass organizer oxide; Li₂O is beneficial to promoting melting and increasing strength of the glass, and can also reduce a thermal expansion coefficient of the glass; the purpose of adding Na₂O and MgO is to reduce the melting temperature of the glass; introduction of CaO can enhance chemical stability of the glass, reduce high-temperature viscosity of the molten glass, and promote melting and clarification of the glass; Al₂O₃ can improve strength and hardness of the glass; and TiO₂+ZrO₂ is a nucleating agent.

As an optional implementation, the glass provided by the present embodiment comprises the following raw materials in parts by weight: 76 parts of SiO₂, 10 parts of Li₂O, 12 parts of Na₂O and 2 parts of TiO₂+ZrO₂.

In order to verify the performance of the glass raw materials with the above mixed components, in the present embodiment, a reflectivity curve of the glass with the mixed components is measured by a transmittance detector. As found, the average reflectivity of the glass with the mixed components is greater than or equal to 92.1% when a wavelength of light is between 400 nm-1200 nm; and the average reflectivity of an original glass plate without addition of Li₂O is 90.2%-91.8% in the wavelength range of the light. Therefore, under the same conditions, the average reflectivity of the glass with the above mixed components is obviously higher than that of the original glass plate without addition of Li₂O.

In order to further verify the performance of the glass formed by the glass raw materials with the above mixed components, the glass formed by the glass raw materials with the above mixed components is tested by a compressive stress meter. As found, the compressive stress of the glass formed by the glass raw materials with the above mixed components is 800 CS/MPa-900 CS/MPa.

The compressive stress value and other performance of the glass formed by the glass raw materials with the above mixed components are further explained with reference to Table 1 below.

As shown in Table 1, Table 1 is a comparison table of compressive stress values and other performance of glass manufactured by several companies in the market with those of the glass manufactured in the present embodiment.

As another optional implementation, the glass provided by the present embodiment comprises the following raw materials in parts by weight: 61 parts of SiO₂, 6 parts of Li₂O, 2 parts of Na₂O, 5 parts of CaO, 5 parts of MgO, 16 parts of Al₂O₃ and 5 parts of TiO₂+ZrO₂.

In order to verify the performance of the glass raw materials with the above mixed components, in the present embodiment, a reflectivity curve of the glass with the mixed components is measured by a transmittance detector. As found, the average reflectivity of the glass with the mixed components is greater than or equal to 92.2% when a wavelength of light is between 400 nm-1200 nm; and the average reflectivity of an original glass plate without addition of Li₂O is 90.2%-91.8% in the wavelength range of the light. Therefore, under the same conditions, the average reflectivity of the glass with the above mixed components is obviously higher than that of the original glass plate without addition of Li₂O.

TABLE 1

| | Compressive | Depth of | Flexural | Elastic |
|---|---|---|---|---|
| | stress | Layer | strength | modulus E |
| Product | CS/Mpa | DOL/μm | Gpa | Gpa |
| Product | 800-950 | >140 | ≥92 | ≥91 |
| obtained by | | | | |
| the present | | | | |
| embodiment | | | | |
| Product 1 of | 700-900 | >40 | ≤78 | ≤75 |
| Company A | | | | |
| Product 2 of | 750-950 | >120 | ≤78 | ≤75 |
| Company A | | | | |
| Product 1 of | 800-1100 | >35 | ≤79 | <78 |
| Company B | | | | |
| Product 2 of | 750-900 | >100 | ≤79 | ≤77 |
| Company B | | | | |
| Product 3 of | 750-940 | >40 | ≤76 | ≤75 |
| Company B | | | | |
| Product of | 700-850 | >120 | ≤81 | ≤80 |
| Company C | | | | |
| Product of | 500-720 | >40 | ≤81 | ≤79 |
| Company D | | | | |
| Product of | 500-820 | >40 | ≤79 | ≤78 |
| Company E | | | | |

The compressive stress value and other performance of the glass formed by the glass raw materials with the above mixed components are explained with reference to Table 2 below.

TABLE 2

| | Compressive | Depth of | Flexural | Elastic |
|---|---|---|---|---|
| | stress | Layer | strength | modulus E |
| Product | CS/Mpa | DOL/μm | Gpa | Gpa |
| Product | 800-950 | >140 | ≥86 | ≥85 |
| obtained by | | | | |
| the present | | | | |
| embodiment | | | | |
| Product 1 of | 700-900 | >40 | ≤78 | ≤75 |
| Company A | | | | |
| Product 2 of | 750-950 | >120 | ≤78 | ≤75 |
| Company A | | | | |
| Product 1 of | 800-1100 | >35 | ≤79 | ≤78 |
| Company B | | | | |
| Product 2 of | 750-900 | >100 | ≤79 | ≤77 |
| Company B | | | | |
| Product 3 of | 750-940 | >40 | ≤76 | ≤75 |
| Company B | | | | |
| Product of | 700-850 | >120 | ≤81 | ≤80 |
| Company C | | | | |
| Product of | 500-720 | >40 | ≤81 | ≤79 |
| Company D | | | | |
| Product of | 500-820 | >40 | ≤79 | ≤78 |
| Company E | | | | |

As shown in Table 2, Table 2 is a comparison table of compressive stress values and other performance of glass manufactured by several companies in the market with those of the glass manufactured in the present embodiment.

As further another optional implementation, the glass provided by the present embodiment comprises the following raw materials in parts by weight: 70 parts of SiO₂, 8 parts of Li₂O, 10 parts of Na₂O, 1.5 parts of CaO, 1.5 parts of MgO, 5 parts of Al₂O₃ and 4 parts of TiO₂+ZrO₂.

In order to verify the performance of the glass raw materials with the above mixed components, in the present embodiment, a reflectivity curve of the glass with the mixed components is measured by a transmittance detector. As found, the average reflectivity of the glass with the mixed components is greater than or equal to 92.3% when a wavelength of light is between 400 nm-1200 nm; and the average reflectivity of an original glass plate without addition of Li₂O is 90.2%-91.8% in the wavelength range of the light. Therefore, under the same conditions, the average reflectivity of the glass with the above mixed components is obviously higher than that of the original glass plate without addition of Li₂O.

In order to further verify the performance of the glass formed by the glass raw materials with the above mixed components, the glass formed by the glass raw materials with the above mixed components is tested by a compressive stress meter. As found, the compressive stress of the glass formed by the glass raw materials with the above mixed components is 800 CS/MPa-900 CS/MPa. The compressive stress value and other performance of the glass formed by the glass raw materials with the above mixed components are explained with reference to Table 3 below.

TABLE 3

| | Compressive | Depth of | Flexural | Elastic |
|---|---|---|---|---|
| | stress | Layer | strength | modulus E |
| Product | CS/Mpa | DOL/μm | Gpa | Gpa |
| Product | 800-950 | >140 | ≥89 | ≥87 |
| obtained by | | | | |
| the present | | | | |
| embodiment | | | | |
| Product 1 of | 700-900 | >40 | ≤78 | ≤75 |
| Company A | | | | |
| Product 2 of | 750-950 | >120 | ≤78 | ≤75 |
| Company A | | | | |
| Product 1 of | 800-1100 | >35 | ≤79 | ≤78 |
| Company B | | | | |
| Product 2 of | 750-900 | >100 | ≤79 | ≤77 |
| Company B | | | | |
| Product 3 of | 750-940 | >40 | ≤76 | ≤75 |
| Company B | | | | |
| Product of | 700-850 | >120 | ≤81 | ≤80 |
| Company C | | | | |
| Product of | 500-720 | >40 | ≤81 | ≤79 |
| Company D | | | | |
| Product of | 500-820 | >40 | ≤79 | ≤78 |
| Company E | | | | |

As shown in Table 3, Table 3 is a comparison table of compressive stress values and other performance of glass manufactured by several companies in the market with those of the glass manufactured in the present embodiment.

It should be noted that the glass raw materials with each of the above mixed components are put in the melting furnace, melted at a temperature of about 1610° C., then pressed and molded, annealed, crystallized and polished to make the final glass product.

The glass provided by the present embodiment comprises the following raw materials in parts by weight: 61-76 parts of SiO₂, 6-10 parts of Li₂O, 2-12 parts of Na₂O, 5-0 parts of CaO, 5-0 parts of MgO, 16-0 parts of Al₂O₃ and 5-2 parts of TiO₂+ZrO₂. Therefore, the glass provided by the present embodiment has better performance and higher mechanical strength.

An embodiment of the present application further provides a glass forming method, wherein the glass is made by the glass forming method.

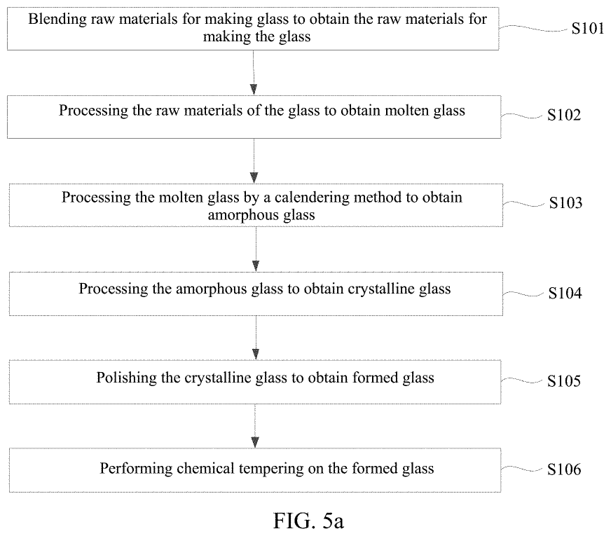

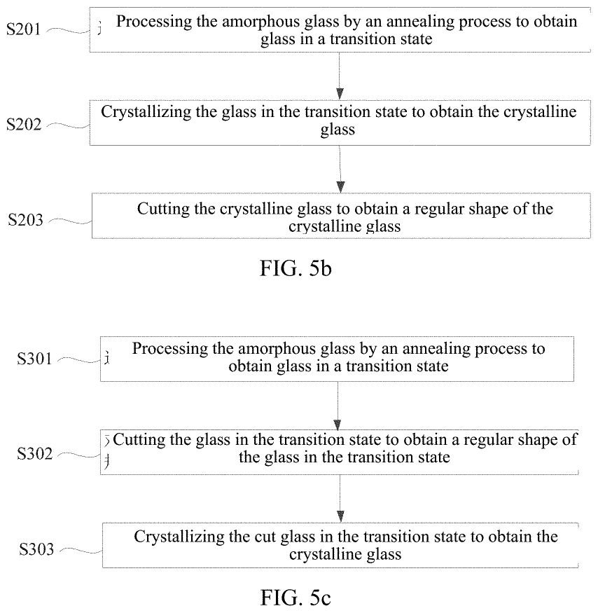

FIG. 5a is a schematic diagram of a step process of a glass forming method provided by an embodiment of the present application. FIG. 5b is a schematic diagram of a step process of processing amorphous glass to obtain crystalline glass in a glass forming method provided by an embodiment of the present application. FIG. 5c is a schematic diagram of another step process of processing amorphous glass to obtain crystalline glass in a glass forming method provided by an embodiment of the present application.

As shown in FIG. 5a and FIG. 5b, the glass forming method provided by the present embodiment comprises:

S101, blending raw materials for making glass to obtain the raw materials for making the glass.

Specifically, the glass comprises the following raw materials in parts by weight: 61-76 parts of SiO₂, 6-10 parts of Li₂O, 2-12 parts of Na₂O, 5-0 parts of CaO, 5-0 parts of MgO, 16-0 parts of Al₂O₃ and 5-2 parts of TiO₂+ZrO₂.

It should be noted that in the above implementations, the glass raw materials with each of the mixed components have been introduced in detail, so the details will not be repeated here.

S102, processing the raw materials of the glass to obtain molten glass.

Specifically, the raw materials of the glass can be put in the melting furnace for melting of the raw materials of the glass, so as to obtain the molten glass.

S103, processing the molten glass by a calendering method to obtain amorphous glass.

Specifically, the calendering method can be carried out by a calender.

S104, processing the amorphous glass to obtain crystalline glass.

In this way, the amorphous glass becomes the crystalline glass, which is convenient for subsequent processing of the glass.

S105, polishing the crystalline glass to obtain formed glass.

Specifically, the crystalline glass can be polished by a polishing machine.

In some embodiments, processing the amorphous glass to obtain the crystalline glass comprises:

S201, processing the amorphous glass by an annealing process to obtain glass in a transition state.

In this way, the hardness of the glass can be reduced; and crystal grains of the glass can be refined to improve the performance of the obtained glass.

S202, crystallizing the glass in the transition state to obtain the crystalline glass.

In this way, the crystal grains of the glass can be further refined to improve the performance of the obtained glass.

S203, cutting the crystalline glass to obtain a regular shape of the crystalline glass.

In this way, subsequent use of the glass is facilitated.

As shown in FIG. 5c, in some embodiments, processing the amorphous glass to obtain the crystalline glass comprises:

S301, processing the amorphous glass by an annealing process to obtain glass in a transition state.

S302, cutting the glass in the transition state to obtain a regular shape of the glass in the transition state.

In this way, subsequent processing of the glass is facilitated; and the crystal grains of the glass can be refined.

S303, crystallizing the cut glass in the transition state to obtain the crystalline glass.

In this way, the crystal grains of the glass can be refined for the second time to improve the performance of the produced glass.

In the present embodiment, crystallizing comprises online crystallizing or offline crystallizing.

In the present embodiment, after warehousing the formed glass, the method further comprises: performing chemical tempering on the warehoused glass, so that the formed glass has higher mechanical strength and better performance.

According to the glass forming method provided by the present embodiment, the glass forming method comprises: blending raw materials for making glass to obtain the raw materials for making the glass; processing the raw materials of the glass to obtain molten glass; processing the molten glass by a calendering method to obtain amorphous glass; processing the amorphous glass to obtain crystalline glass; and polishing the crystalline glass to obtain formed glass. The glass made by the glass forming method provided by the present embodiment has better performance and higher mechanical strength.

An embodiment of the present application further provides a pressing apparatus, which is used to process the molten glass to obtain the amorphous glass in the above forming method. The present embodiment will be described in detail below with reference to the drawings and specific implementations.

It should be noted that the basis of the pressing apparatus provided by the present embodiment is a “lever balance condition” of a lever principle. Specifically, in order to balance a lever, two moments (a product of force and a moment arm) acting on the lever must be equal in magnitude, that is, power×power arm=resistance×resistance arm, which is expressed by an algebraic expression: F1·L1=F2·L2, where: F1 represents power; L1 represents a power arm; F2 represents resistance; and L2 represents a resistance arm. As shown in above formular, to balance the lever, the number of times of the power arm towards the resistance arm is equal to the number of times of the resistance towards the power.

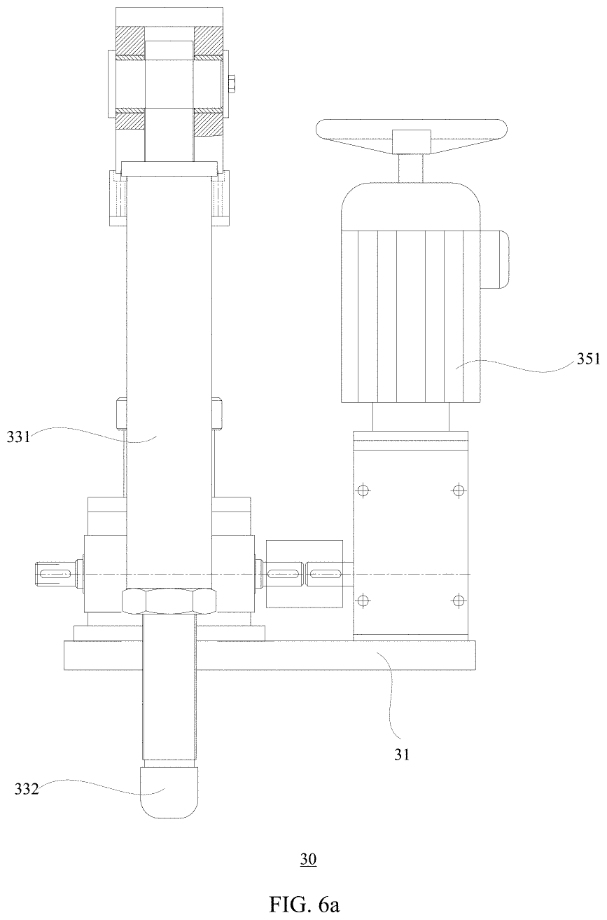

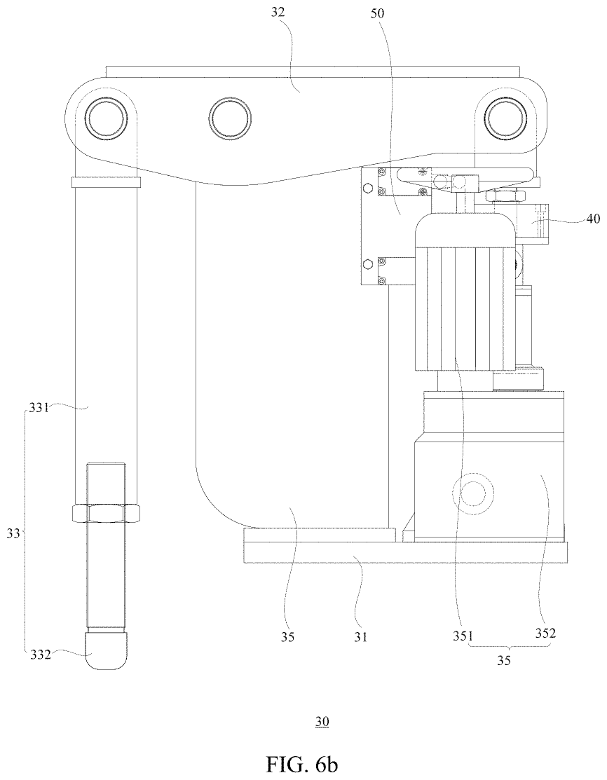

FIG. 6a is a structural schematic diagram of a pressing apparatus provided by an embodiment of the present application. FIG. 6b is a side view of FIG. 6a.

As shown in FIG. 6a and FIG. 6b, the pressing apparatus provided by the embodiment of the present application comprises two oppositely arranged pressing mechanisms 30; each pressing mechanism 30 comprises a base 31, a cross beam 32, a pressing rod 33, a stand column 34, and a driving mechanism 35; the stand column 34 and the driving mechanism 35 are mounted on the base 31; the first end of the pressing rod 33, the end of the stand column 34 distant from the base 31, and the end of the driving mechanism 35 distant from the base 31 are all pivoted to the cross beam 32; and the stand column 34 is located between the pressing rod 33 and the driving mechanism 35.

In the present embodiment, connection between the stand column 34 and the base 31, and connection between the driving mechanism 35 and the base 31 can adopt a connecting mode of threaded connection or a connecting mode of welding connection. It should be noted that the purpose of the present embodiment can be achieved by any connection mode which can realize reliable connection between the stand column 34 and the base 31 and between the driving mechanism 35 and the base 31.

In an optional implementation, the driving mechanism 35 comprises a motor reducer 351 and a turbine lifting reducer 352; the motor reducer 351 is connected to an input shaft of the turbine lifting reducer 352 through a coupling; and a screw rod conductor on the top end of the turbine lifting reducer 352 is rotationally connected to the cross beam 32 through a pin shaft.

Specifically, by starting the motor reducer 351, the screw rod conductor on the turbine lifting reducer 352 drives one end of the cross beam 32 to ascend or descend; and then the pressing rod 33 at the other end of the cross beam 32 descends or ascends.

In another optional implementation, the driving mechanism 35 comprises a handwheel and a turbine lifting reducer 352; and the handwheel is rotationally connected to an input shaft of the turbine lifting reducer 352 through a positioning pin.

Specifically, by rotating the handwheel, the screw rod conductor on the turbine lifting reducer 352 drives one end of the cross beam 32 to ascend or descend; and then the pressing rod 33 at the other end of the cross beam 32 descends or ascends.

In further another optional implementation, the driving mechanism 35 is a mechanical jack, one end of which is connected to the base 31; and the other end of which is pivoted to the cross beam 32. By making the mechanical jack work, the mechanical jack drives one end of the cross beam 32 to ascend or descend; and then the pressing rod 33 at the other end of the cross beam 32 descends or ascends.

In a specific implementation of the present embodiment, the pressing rod 33 comprises an upper pressing rod 331 and a pressing rod head 332; a first end of the upper pressing rod 331 is pivoted to the cross beam 32; and a second end of the upper pressing rod 331 is in threaded connection with the pressing rod head 332.

In this way, the upper pressing rod 331 and the pressing rod head 332 can be mounted and dismounted easily; and the pressing rod head 332 can be replaced easily.

As an optional implementation, the pressing apparatus provided by the present embodiment further comprises a pressure sensor 40; a first end of pressure sensor 40 is connected to the driving mechanism 35; and a second end of the pressure sensor 40 is pivoted to the cross beam 32.

In the present embodiment, the pressure sensor 40 is used to detect force applied to the end of the pressing rod 33.

In some embodiments, the pressing apparatus provided by the present application further comprises a limiting switch 50; the limiting switch 50 is arranged on the stand column 34; the limiting switch 50 has a first contact point and a second contact point; the first contact point can be abutted against a first end surface of the pressure sensor 40; and the second contact point can be abutted against a second end surface of the pressure sensor 40.

Specifically, when a housing of the pressure sensor 40 touches the first contact point or the second mechanical contact point of the limiting switch 50, the motor reducer 351 stops actions and realizes automatic protection.

In a specific implementation of the present embodiment, the limiting switch 50 is connected to the stand column 34 by a threaded fastener.

The pressing apparatus provided by the embodiment of the present invention comprises two oppositely arranged pressing mechanisms; each pressing mechanism comprises a base, a cross beam, a pressing rod, a stand column, and a driving mechanism; the stand column and the driving mechanism are mounted on the base; the first end of the pressing rod, the end of the stand column distant from the base, and the end of the driving mechanism distant from the base are all pivoted to the cross beam; and the stand column is located between the pressing rod and the driving mechanism. The pressing apparatus provided by the present embodiment can press the glass with different thicknesses, so that the pressed glass has better performance.

An embodiment of the present application further provides a calender. The present embodiment will be described in detail below with reference to the drawings.

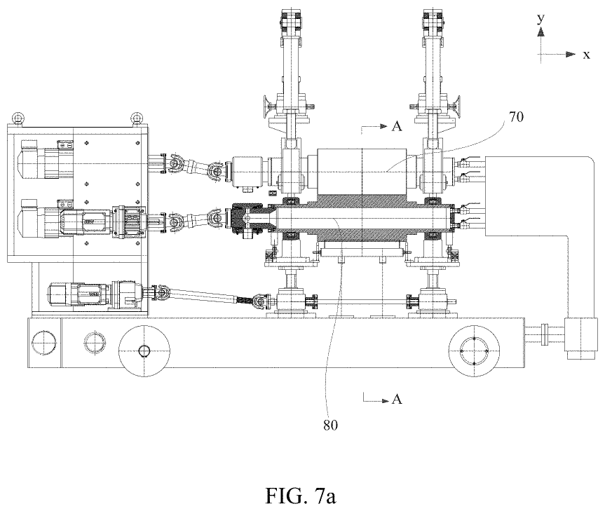

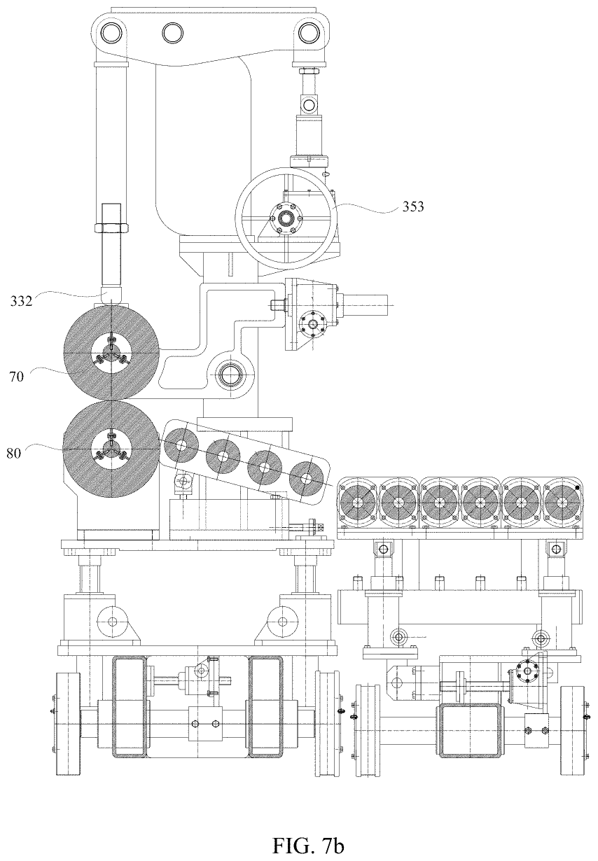

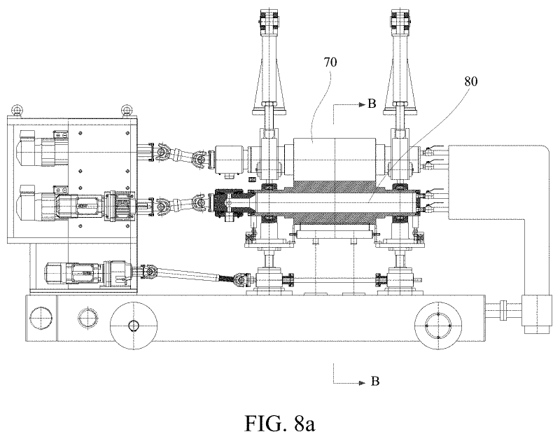

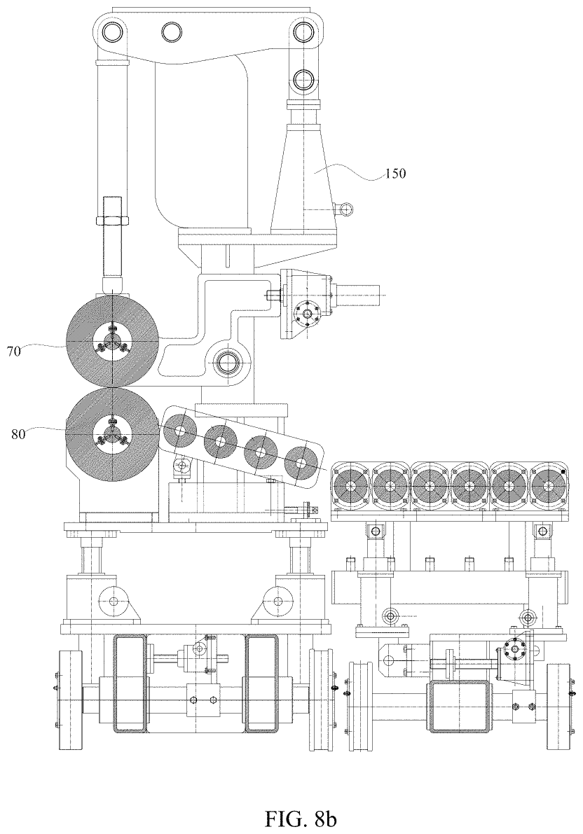

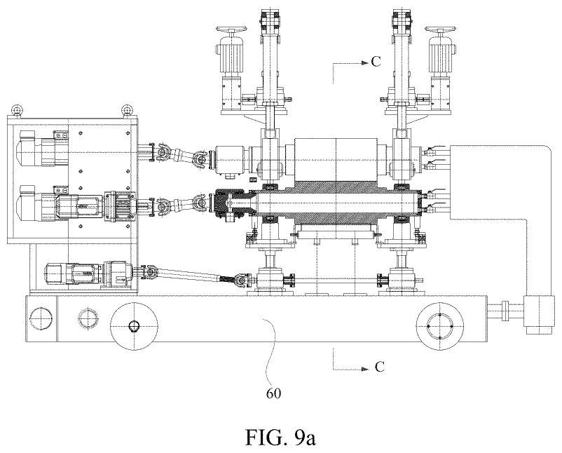

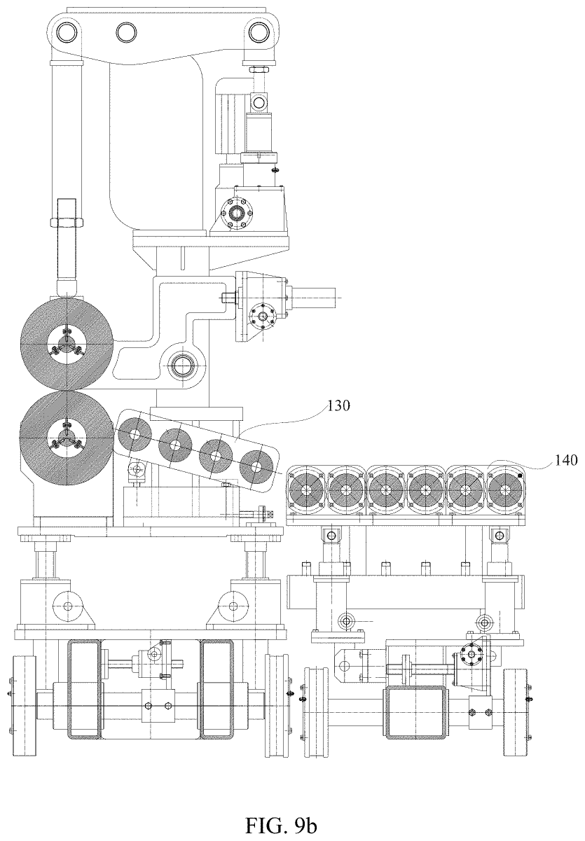

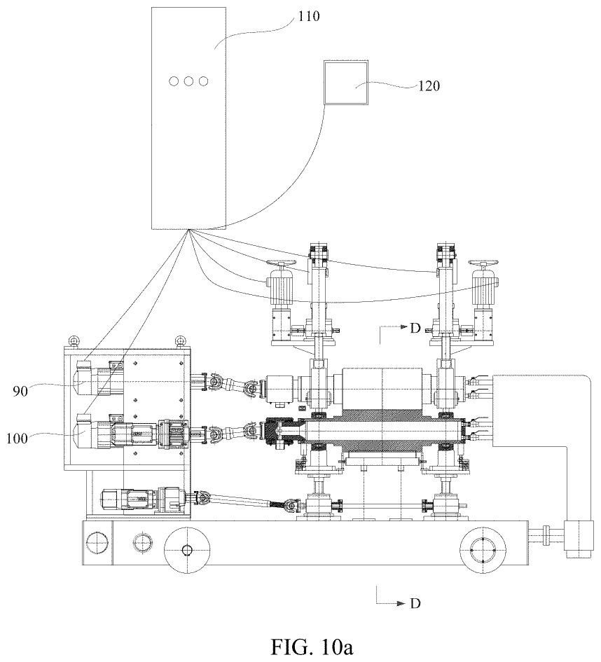

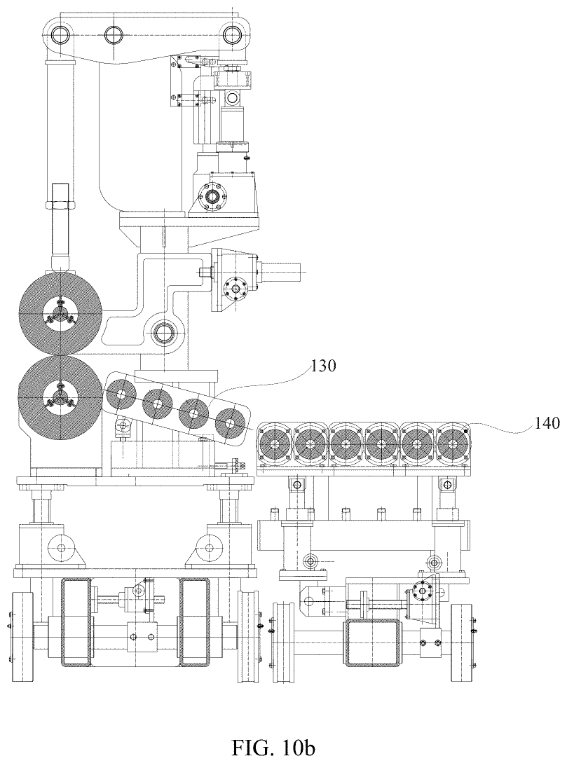

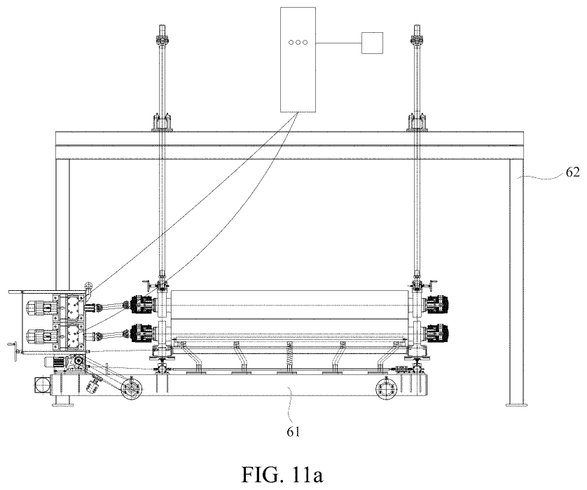

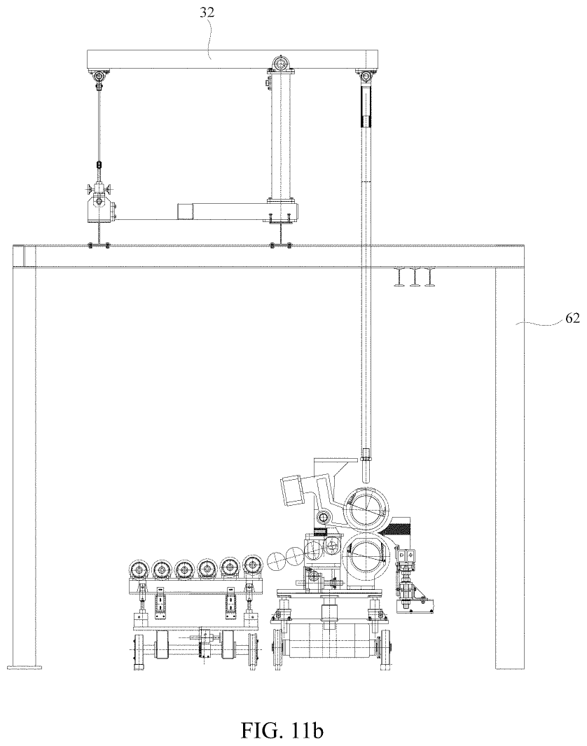

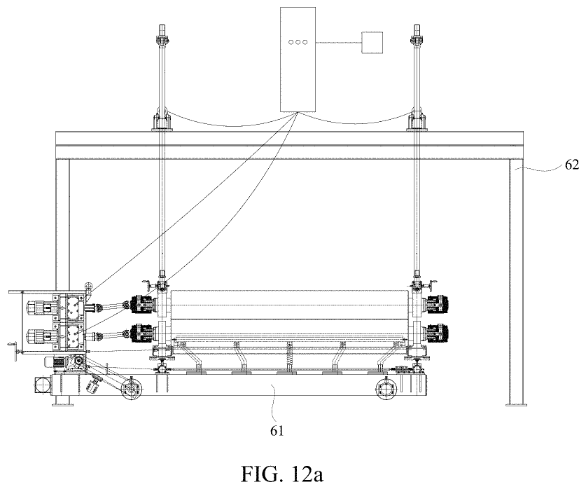

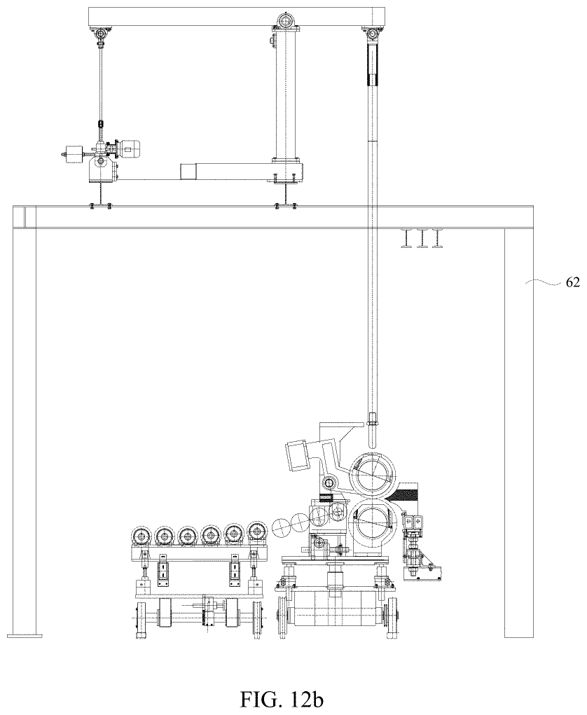

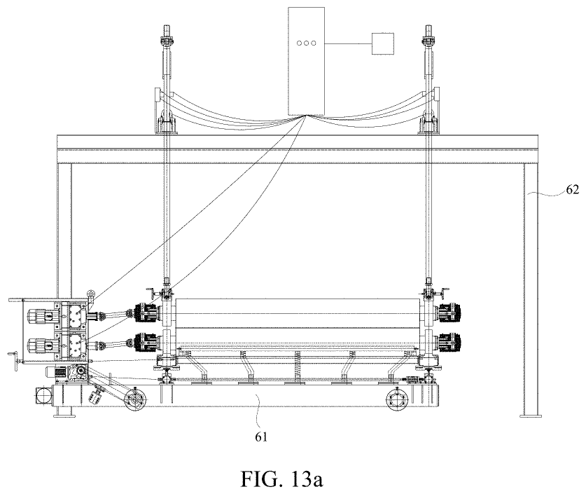

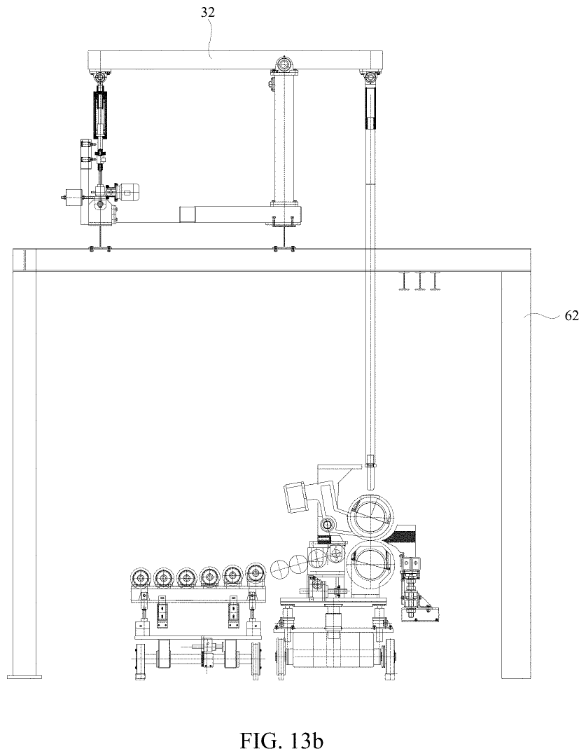

FIG. 7a is a schematic diagram of a first structure of a calender provided by an embodiment of the present application. FIG. 7b is a cross-sectional view of FIG. 7a along A-A. FIG. 8a is a schematic diagram of a second structure of a calender provided by an embodiment of the present application. FIG. 8b is a cross-sectional view of FIG. 8a along B-B. FIG. 9a is a schematic diagram of a third structure of a calender provided by an embodiment of the present application. FIG. 9b is a cross-sectional view of FIG. 9a along C-C. FIG. 10a is a schematic diagram of a fourth structure of a calender provided by an embodiment of the present application. FIG. 10b is a cross-sectional view of FIG. 10a along D-D. FIG. 11a is a schematic diagram of a fifth structure of a calender provided by an embodiment of the present application. FIG. 11b is a side view of FIG. 11a. FIG. 12a is a schematic diagram of a sixth structure of a calender provided by an embodiment of the present application. FIG. 12b is a side view of FIG. 12a. FIG. 13a is a schematic diagram of a seventh structure of a calender provided by an embodiment of the present application. FIG. 13b is a side view of FIG. 13a.

As shown in FIG. 7a to FIG. 13b, an embodiment of the present application provides a calender, which comprises a calender body 60, a calendering upper main roller 70, a calendering lower main roller 80 and the pressing apparatus. The calendering upper main roller 70 and the calendering lower main roller 80 are oppositely arranged on the calender body 60; distribution directions of the calendering upper main roller 70 and the calendering lower main roller 80 are consistent with a longitudinal direction of the calender body 60 (y direction in the diagram); the molten glass can be located between the calendering upper main roller 70 and the calendering lower main roller 80; and the pressing apparatus is arranged on the calender body 60. Specifically, the base 31 is connected to the calender body 60 by a connection mode of welding; and the second end of the pressing rod 33 can press against the calendering upper main roller 70, that is, the pressing rod head 332 can press against the calendering upper main roller 70.

It should be noted that the specific structure of the pressing apparatus has been described in detail in the above implementations; and the specific structure of the pressing apparatus will not be described in detail here.

As shown in FIG. 7a and FIG. 7b, as an optional implementation, the driving mechanism 35 comprises a handwheel 353 and a turbine lifting reducer 352; and the handwheel 353 is rotationally connected to an input shaft of the turbine lifting reducer 352 through a positioning pin.

Specifically, by rotating the handwheel 353, the screw rod conductor on the turbine lifting reducer 352 drives one end of the cross beam 32 to ascend or descend; and then the pressing rod 33 at the other end of the cross beam 32 descends or ascends, thereby changing the pressure generated by the calendering upper main roller 70 on the molten glass.

As shown in FIG. 8a and FIG. 8b, as another optional implementation, the driving mechanism 35 is a mechanical jack 150; one end of the mechanical jack 150 is connected to the base 31; and the other end of the mechanical jack 150 is pivoted to the cross beam 32. By making the mechanical jack 150 work, the mechanical jack 150 drives one end of the cross beam 32 to ascend or descend; and then the pressing rod 33 at the other end of the cross beam 32 descends or ascends, thereby changing the pressure generated by the calendering upper main roller 70 on the molten glass.

As shown in FIG. 9a to FIG. 10b, as further another optional implementation, the driving mechanism 35 comprises a motor reducer 351 and a turbine lifting reducer 352; the motor reducer 351 is connected to an input shaft of the turbine lifting reducer 352 through a coupling; and a screw rod conductor on the top end of the turbine lifting reducer 352 is rotationally connected to the cross beam 32 through a pin shaft. Specifically, by starting the motor reducer 351, the screw rod conductor on the turbine lifting reducer 352 drives one end of the cross beam 32 to ascend or descend; and then the pressing rod 33 at the other end of the cross beam 32 descends or ascends, thereby changing the pressure generated by the calendering upper main roller 70 on the molten glass.

As shown in FIG. 11a to FIG. 13b, the calender body 60 comprises a first body 61 and a second body 62; the second body 62 comprises a workbench; the workbench is located above the first body 61; the calendering upper main roller 70 and the calendering lower main roller 80 are both arranged on the first body 61; the pressing apparatus is arranged on the workbench; and the pressing rod 33 penetrates through the workbench.

In a specific implementation of the present embodiment, the second body 62 is welded by I-beams or channel steel.

In order to realize automatic operations of the calender provided by the present embodiment, in the present embodiment, the calender further comprises a calendering upper main roller motor 90, a calendering lower main roller motor 100, an electric control cabinet 110 and a touch screen 120; a motor shaft of the calendering upper main roller motor 90 is connected to the calendering upper main roller 70; a motor shaft of the calendering lower main roller motor 100 is connected to the calendering lower main roller 80; the electric control cabinet 110 and the touch screen 120 are arranged on the calender body 60; and the calendering upper main roller motor 90, the calendering lower main roller motor 100 and the touch screen 120 are all electrically connected to the electric control cabinet 110.

In this way, the amount of labor of staff can be reduced; and human resources can be saved.

The calender provided by the present embodiment further comprises a plurality of auxiliary rollers 130 and a plurality of movable rollers 140 arranged on the calender body 60. When the molten glass is extruded and molded, the glass will be transmitted to the movable rollers 140 through the auxiliary rollers 130 and then transmitted to other processing equipment through the movable rollers 140.

It should be noted that the extruded and molded glass can be transmitted to equipment for an annealing process after passing the movable rollers 140. Here, the equipment for the annealing process is not limited.

When the calender provided by the present embodiment is used, speed parameters of the calendering upper main roller 70, the calendering lower main roller 80, the auxiliary rollers 130 and the movable rollers 140 are set; the corresponding parameters are displayed on a touch screen 120; a certain pressure parameter is set for the pressure sensor 40 and displayed on the touch screen 120; the touch screen 120 sends a signal to the electric control cabinet 110, so that the electric control cabinet 110 controls the motor reducer 351 on the spot to rotate; hence, the screw rod on the turbine lifting reducer 352 ascends or descends; and the pressing rod 33 is driven to ascend or descend, so that the liquid molten glass in the molten state is pressed into the glass with a certain thickness after passing the calendering upper main roller 70 and the calendering lower main roller 80.

When an actual pressure value detected by the pressure sensor 40 is inconsistent with the set pressure value, the electric control cabinet 110 will drive the motor reducer 351 to act and drive the turbine lifting reducer 352 to ascend or descend; and the acting force will realize ascending or descending of the pressing rod 33 through a rotation fulcrum on the stand column 34, so as to control the force applied by the pressing rod 33 on the calendering upper main roller 70. Until the actual pressure value detected by the pressure sensor 40 is the same as the set pressure value, the motor reducer 351 stops the action.

In case of a circuit accident and malfunctions of the motor reducer 351, the housing of the pressure sensor 40 will touch the first mechanical contact point or the second mechanical contact point of the limiting switch 50. At this time, the electric control cabinet 110 will control the motor reducer 351 to stop working and carry out independent protection after receiving the signal.

It should be noted that the thinner the thickness of the produced glass is, the greater the set pressure value of the pressure sensor 40 will be; and the greater the pressure applied to the calendering upper main roller 70 through the cross beam 32 will be.

The calender provided by the present embodiment comprises a calender body, a calendering upper main roller, a calendering lower main roller and the pressing apparatus. The calendering upper main roller and the calendering lower main roller are oppositely arranged on the calender body; distribution directions of the calendering upper main roller and the calendering lower main roller are consistent with a longitudinal direction of the calender body; the molten glass can be located between the calendering upper main roller and the calendering lower main roller; the pressing apparatus is arranged on the calender body; and the second end of the pressing rod can press against the calendering upper main roller. Because the calender provided by the present embodiment comprises the above pressing apparatus, the calender can press the glass with different thicknesses, so that the pressed glass has better performance.

1. A glass, comprising the following raw materials in parts by weight: 61-76 parts of SiO₂, 6-10 parts of Li₂O, 2-12 parts of Na₂O, 5-0 parts of CaO, 5-0 parts of MgO, 16-0 parts of Al₂O₃ and 5-2 parts of TiO₂+ZrO₂.

2. The glass according to claim 1, comprising the following raw materials in parts by weight: 76 parts of SiO₂, 10 parts of Li₂O, 12 parts of Na₂O and 2 parts of TiO₂+ZrO₂.

3. The glass according to claim 1, comprising the following raw materials in parts by weight: 61 parts of SiO₂, 6 parts of Li₂O, 2 parts of Na₂O, 5 parts of CaO, 5 parts of MgO, 16 parts of Al₂O₃ and 5 parts of TiO₂+ZrO₂.

4. The glass according to claim 1, comprising the following raw materials in parts by weight: 70 parts of SiO₂, 8 parts of Li₂O, 10 parts of Na₂O, 1.5 parts of CaO, 1.5 parts of MgO, 5 parts of Al₂O₃ and 4 parts of TiO₂+ZrO₂.

5. A glass forming method, wherein the glass of claim 1 is made by the glass forming method; and the glass forming method comprises:
blending raw materials for making glass to obtain the raw materials for making the glass;
processing the raw materials of the glass to obtain molten glass;
processing the molten glass by a calendering method to obtain amorphous glass;
processing the amorphous glass to obtain crystalline glass;
polishing the crystalline glass to obtain formed glass.

6. The glass forming method according to claim 5, wherein processing the amorphous glass to obtain the crystalline glass comprises:
processing the amorphous glass by an annealing process to obtain glass in a transition state;
crystallizing the glass in the transition state to obtain the crystalline glass;
cutting the crystalline glass to obtain a regular shape of the crystalline glass; or,
processing the amorphous glass by an annealing process to obtain glass in a transition state;
cutting the glass in the transition state to obtain a regular shape of the glass in the transition state;
crystallizing the cut glass in the transition state to obtain the crystalline glass;
wherein the glass in the transition state is the glass after the amorphous state and before a crystalline state.

7. The glass forming method according to claim 6, wherein the crystallizing comprises online crystallizing or offline crystallizing.

8. The glass forming method according to claim 5, wherein after polishing the crystalline glass to obtain the formed glass, the method further comprises:
performing chemical tempering on the formed glass.

9. A calender, comprising a calender body, a calendering upper main roller, a calendering lower main roller and the pressing apparatus, wherein the calendering upper main roller and the calendering lower main roller are oppositely arranged on the calender body; distribution directions of the calendering upper main roller and the calendering lower main roller are consistent with a longitudinal direction of the calender body; the molten glass can be located between the calendering upper main roller and the calendering lower main roller; the pressing apparatus is arranged on the calender body; and the second end of the pressing rod can press against the calendering upper main roller;
the pressing apparatus comprises two oppositely arranged pressing mechanisms; each pressing mechanism comprises a base, a cross beam, a pressing rod, a stand column, and a driving mechanism; the stand column and the driving mechanism are mounted on the base; a first end of the pressing rod, an end of the stand column distant from the base, and an end of the driving mechanism distant from the base are all pivoted to the cross beam; and the stand column is located between the pressing rod and the driving mechanism.

10. The calender according to claim 9, wherein the calender body comprises a first body and a second body; the second body comprises a workbench; the workbench is located above the first body; the calendering upper main roller and the calendering lower main roller are both arranged on the first body; the pressing apparatus is arranged on the workbench; and the pressing rod penetrates through the workbench.

11. The calender according to claim 9, further comprising a calendering upper main roller motor, a calendering lower main roller motor, an electric control cabinet and a touch screen, wherein a motor shaft of the calendering upper main roller motor is connected to the calendering upper main roller; a motor shaft of the calendering lower main roller motor is connected to the calendering lower main roller; the electric control cabinet and the touch screen are arranged on the calender body; and the calendering upper main roller motor, the calendering lower main roller motor and the touch screen are all electrically connected to the electric control cabinet.
